(19) United States
(12) Patent Application Publication
(10) Pub. No.: US 2012/0179793 A1
(43) Pub. Date: Jul. 12, 2012

(54) Resource Allocation

(75) Inventor: Harsh Jahagirdar, London (GB)

(73) Assignee: NOKIA CORPORATION, Espoo (FI)

(21) Appl. No.: 13/378,349

(22) PCT Filed: Jun. 29, 2009
(86) PCT No.: PCT/IB2009/052815

§ 371 Date: Mar. 22, 2012

(51) Int. Cl. G06F 15/173; G06F 15/177

(52) U.S. Cl. 709/221; 709/226

(57) ABSTRACT

A method of allocating resources in a computing device where resources are allocated to clients according to requests from the clients, said allocation of resources being at least partially determined by system settings, said computing device comprising a message queue where a request from a client for a resource allocation has a corresponding message in said queue, said method comprising the step of prioritising messages in said queue. Said priorities for said messages may comprise, in descending order of priority: messages corresponding to changes which may affect existing resource allocations, messages corresponding to system related requests for resources and then messages corresponding to user related requests for resources.

### TECHNICAL FIELD

The present invention relates to the allocation of resources in a computing device.

### BACKGROUND TO THE INVENTION

Computing devices are increasingly becoming more versatile and capable of completing more tasks than was previously possible. Together with this increase in capabilities there exists a commensurate increase in resources used by the computing device to perform these tasks.

The increase in the number of resources increases the complexity in managing the resources. In the past, the management of resources was treated in an ad hoc manner. Any conflicts in requests for, or the use of, resources would either be specified for the particular requests and resources concerned, or would result in an error.

Recently however the realisation has arisen that a framework needs to be provided in the computing device to manage the allocation of resources which is able to deal with conflicts to the resources and the requests for allocation. Generally, such systems are concerned with receiving requests for resource allocation from clients (which may be software or hardware components) and allocating the resources according to a set of rules.

In a number of systems for resource allocation, such as the multimedia subsystem of the Symbian operating system, requests for resource allocation are dealt with in a queue.

Requests for resource allocation may be dealt with in the order that the requests are received. However, this can result in less important requests being be serviced in preference to more important requests. Furthermore, where two requests pertain to the same resource, this can result in the less important request being allocated the resource in preference to the more important resource.

### SUMMARY OF THE INVENTION

According to a first embodiment, there is provided a method comprising: placing a message corresponding to a request, originating from a client, in a queue of messages; processing said message by allocating a resource of a computing device to the corresponding client with reference to a system setting; maintaining a record of resources allocated to clients; and where said queue of messages comprises more than one message, prioritising the order in which said messages are processed.

According to a second embodiment, there is provided apparatus comprising: at least one processor; and at least one memory including computer program code; the at least one memory and the computer program code being configured to, working with the at least one processor, cause the apparatus to perform at least the following: cause a message, corresponding to a request originating from a client, to be placed in a queue of messages; cause said message to be processed by allocating a computing device resource to the corresponding client with reference to a system setting; cause a record of resources allocated to clients to be maintained; and where said queue of messages comprises more than one message, causing the order in which said messages are processed to be prioritised.

According to a third embodiment there is provided a computer program product comprising a computer-readable medium bearing computer program code embodied therein for use with a computer, the computer program code comprising: code for placing a message corresponding to a request, originating from a client, in a queue of messages; code for processing said message by allocating a resource of a computing device to the corresponding client with reference to a system setting; code for maintaining a record of resources allocated to clients; and code for, where said queue of messages comprises more than one message, prioritising the order in which said messages are processed.

Also described is a computer program comprising: code for placing a message corresponding to a request, originating from a client, in a queue of messages; code for processing said message by allocating a resource of a computing device to the corresponding client with reference to a system setting; code for maintaining a record of resources allocated to clients; and code for, where said queue of messages comprises more than one message, prioritising the order in which said messages are processed.

Prioritising the messages in the queue allows the more important messages may be processed first, so that the more important clients are provided with resources in preference to less important clients. This enables critical client requests to be processed with minimal delay.

Embodiments provide an effective way in which potential conflicts between resource requests may be resolved. The requests corresponding to the more important clients are processed first. If a later request, belonging to a less important client, pertains to a resource which is no longer available as it has been allocated to a more important client, the later request may generate an error. Therefore it is not necessary to provide a distinct set of rules to deal with conflicts for these embodiments of the invention.

The order in which said messages are processed may be prioritised according to a set of rules.

By prioritising the order of the processing of the messages in the queue according to a set of rules, an easily implemented system for allocating resources and prioritising requests for resources is provided.

The requests may originate from a user client or a system client and, in this instance, messages originating from system clients may be prioritised over those originating from user clients.

By prioritising requests for resources originating from system clients over those originating from user clients, a rule is provided for prioritising resource requests which is relatively easy to implement and which provides a robust way for distinguishing between resource requests. This permits better prioritisation due to the fact that system requests are, generally speaking, more critical than user requests.

At least one of said messages in said queue may comprise a message relating to a system change which may affect existing allocations of resources, said method may then comprise the step of prioritising said message relating to said system change over messages corresponding to client requests for resource allocation.

Messages relating to a system change which may affect existing allocations are advantageously prioritised over requests for resources originating from clients as this minimizes the computation involved in processing the messages. If the message corresponding to the system change were not prioritised over those corresponding to client requests, any client requests processed prior to the system change may have to be reallocated if the system change affects these requests, resulting in unnecessary processing.

The change which may affect existing allocations of resources may originate from a change to a user profile.

The change which may affect existing allocations of resources may further originate from a change to said one or more system settings.

The change which may affect said existing allocation of resources may further originate from a change to a hardware component.

The change to the hardware component may comprise one or more of: installing said hardware component; removing said hardware component; or changing a setting of said hardware component.

A plurality of clients may have corresponding security ratings determining a level of trustworthiness of the clients, and in this instance, said method may comprise the step of prioritising the messages according to the security rating of the corresponding clients.

The queue may be adapted so that said messages may be processed sequentially.

A message queue where messages may be sequentially provides a structure whereby prioritisation of the messages in the queue may be implemented relatively easily. Where the messages are processed sequentially, the messages in the queue may be prioritised according to their position in the queue.

The queue may be a first in, first out queue.

The messages may be added to the queue according to the prioritisation of the messages.

The resources may be multimedia resources and may include at least one media source, media effect, decoder, encoder, or media sink.

The record of the resource allocated to the client may comprises at least one filter graph, said filter graph linking said client and said resource of said record.

Some embodiments extend to a program for a computer adapted to perform the aforementioned method, an operating system comprising this computer program and a computing device comprising this operating system.

### BRIEF DESCRIPTION OF THE DRAWINGS

Embodiments are hereinafter described with reference to the accompanying diagrams where like numerals are used to refer to like components and where:

FIG. 1 is a schematic representation of a mobile computing device;

FIG. 2 is a schematic representation of elements of the mobile computing device of FIG. 1;

FIG. 3 is a schematic representation of connections between client applications and a context manager;

FIG. 4 is a schematic representation of connections between system components and a system state manager;

FIG. 5 is a schematic representation of a system settings interface of the mobile computing device of FIG. 1;

FIG. 6 is a schematic representation of the connections of elements of a multimedia subsystem of the mobile computing device of FIG. 1;

FIG. 7 is a schematic representation of a message queue;

FIG. 8 is a process diagram illustrating the operation of an embodiment;

FIG. 9 is a process diagram illustrating a portion of the embodiment of FIG. 8; and

FIG. 10 is an illustration of two filter graphs.

### DETAILED DESCRIPTION

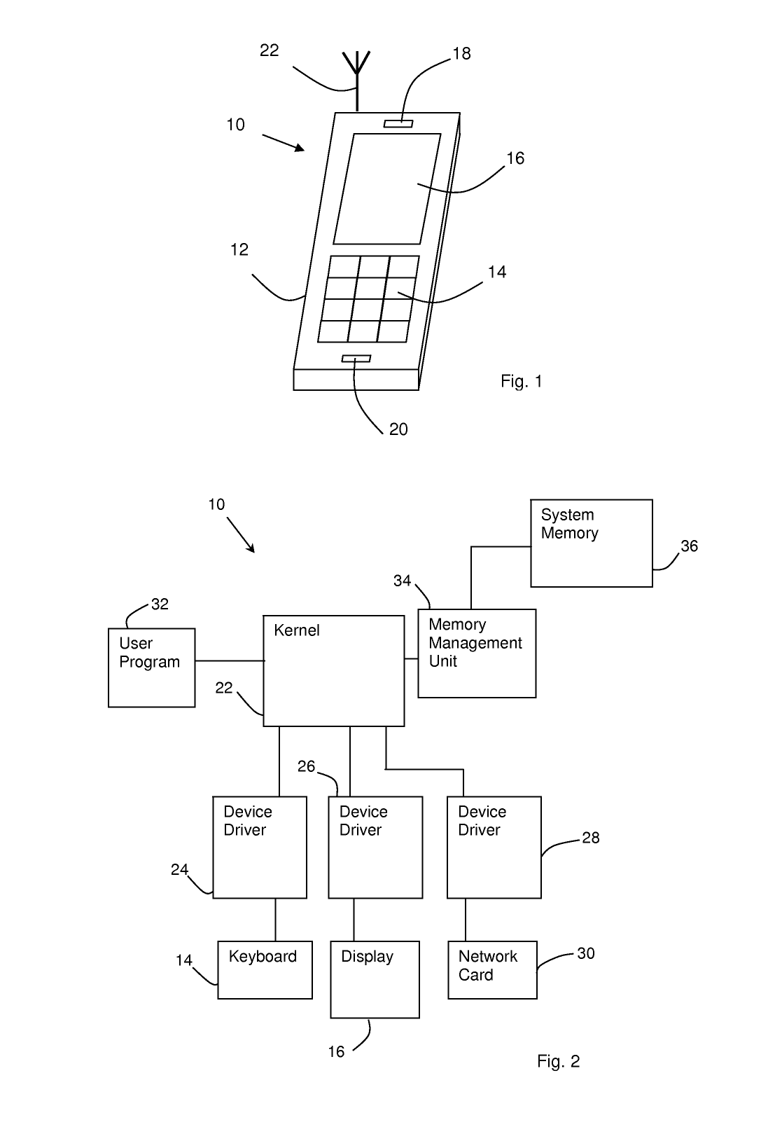

FIG. 1 is a schematic diagram of an exemplary mobile computing device 10 having a casing 12. The casing 12 encapsulates a keypad 14, a screen 16, a speaker 18 and a microphone 20. The device 10 further includes an antenna 22. The mobile computing device 10 illustrated in FIG. 1 may function as a phone and, in this instance, sends and receives telecommunication signals via antenna 22.

FIG. 2 is a schematic illustration of certain components of the mobile computing device 10. Device 10 includes a kernel 38 which represents the operating system of the device 10. In the embodiment shown, the operating system is the Symbian operating system. The kernel 38 is connected to a system memory 36 which is controlled by means of a memory management unit 34. Device drivers 24, 26 and 28 are connected to the kernel 38 and control the behaviour of, and communication with, respective devices: keyboard 14, display 16 and network card 30. A user interacts with the device 10 by means of user programs, one of which, user program 32, is illustrated in FIG. 2. User program 32 communicates with the hardware of the device 10 (such as the display 16) by means of the kernel 38. It is to be realised that the mobile computing device 10 includes many more devices and components than those illustrated here.

The system memory 36 contains software needed to operate the device 10 and, when the device is switched on, software in the system memory establishes the kernel 38, device drivers 24, 26 and 28, user program 32 and all other required software. The software may be copied to the system memory 36 during manufacture of the device 10 as a software image.

Embodiments of the invention will be hereinafter described with reference to the Symbian operating system and, in particular, the multimedia subsystem of the Symbian operating system. It is to be realised however that the invention is not limited in this respect and may just as easily be applied to apparatus using other operating systems, and to the allocation of resources other than multimedia resources.

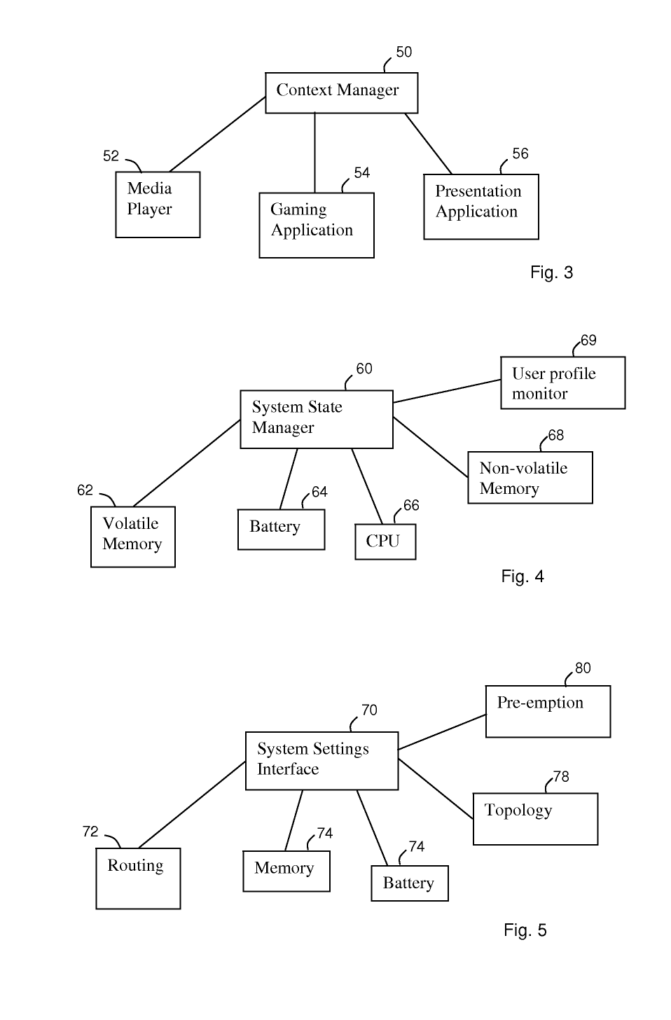

FIG. 3 illustrates a context manager 50 which forms part of the kernel 38 illustrated in FIG. 2. The context manager 50 is connected to a plurality of user programs of which three: media player 52, gaming application 54 and presentation application 56 are illustrated in FIG. 3. It is to be realised however that many more such user programs may be connected to context manager 50 and that the illustration of FIG. 3 is presented merely by way of example. Each software component (other than those forming part of the kernel 38) which may require a multimedia resource is registered with the context manager and the context manager manages these resources in a manner described below. The context manager 50 is concerned with software applications in user space.

FIG. 4 illustrates a system state manager 60 which forms part of the kernel 38 and which is connected to a plurality of system components. In the depiction of FIG. 4, the following system components are connected to system state manager 60: volatile memory 62, battery 64, central processing unit (CPU) 66, non-volatile memory 68 and user profile monitor 69. Once again, it is to be realised that the depiction of FIG. 4 is presented merely by way of example and that the system state manager 60 may be connected to different system resources. The system state manager may be connected to any software component forming part of the kernel 38, and to any hardware component, which affect the system state and which may require a system notification to be issued to the user of the device or to any hardware component which may affect the system settings described below.

So, for example, the system state manager 60 is connected to battery 64 and when the battery reaches a predetermined charge level (generally a charge level which requires action by the user to prevent the device from becoming inactive) the system state manager is made aware thereof and will initiate the process whereby a notification is issued to the user.

Similarly, the system state manager 60 monitors the volatile memory 62, CPU 66 and non-volatile memory 68 and determines when notifications in respect of these components are to be issued.

The user profile monitor 69 may be connected to user profiles. Each user profile specifies, amongst others, settings which affect the multimedia subsystem. For example, a certain user profile may direct all audio output to a vibrator (not shown), specify a maximum volume, specify a default video display device etc. Therefore, the user profile monitor 69 monitors the current active profile and if a setting of this profile is changed, then the user profile monitor 69 informs the system state manager 60 thereof. Where the change relates to resources for the multimedia subsystem the system state manager 60 initiates the process whereby a re-allocation of multimedia resources can occur (in the manner described below).

FIG. 5 illustrates system settings interface 70 which may comprise part of the kernel 38 of the computing device illustrated in FIGS. 1 and 2. The system settings interface 70 is an interface to those settings of the computing device which affect and influence a manner in which multimedia resources might be allocated to particular clients. The interface 70 of FIG. 5 provides an interface to the following system settings: routing 72, memory 74, battery 76, topology 78 and pre-emption 80. Each of these system settings may, under certain circumstances, affect the manner in which resources may be allocated.

The pre-emption system settings 80 determine which processes have precedence over other processes. The topology system settings 78 determine the connections of multimedia resources such as screens and speakers or headphones and the routing system settings 72 which determine how a particular resource may be accessed. Memory system settings 74 and battery system settings 76 determine how resources are allocated in dependence on the state of the memory and the battery, respectively.

Therefore the system settings which are interfaced by the interface 70 furthermore provide a set of policies which determines how resources are to be allocated in dependence on the states and characteristics of components of the computing device 10.

It is to be realised that the system settings illustrated in FIG. 5 are shown merely by way of example and that an interface may be provided to many other system settings. For example, other system settings determine how resources are to be allocated in dependence on the state of other hardware components such as the CPU state.

The system state manager 60 of FIG. 4 has access to the system settings illustrated in FIG. 5 and is able to determine those system settings which pertain to the components monitored by the system state manager. For example, whilst the system state manager 60 may be connected to the battery 64, the battery system setting can 74 determine the parameters which determine when the system state manager 60 issues a notification relating to the status of the battery.

For other operations of the system state manager 60, reference may be made to corresponding settings interfaced at 70, or the system state manager 60 may have access to rules independent of the interface 70 which determine the appropriate action to be taken by the system state monitor 70.

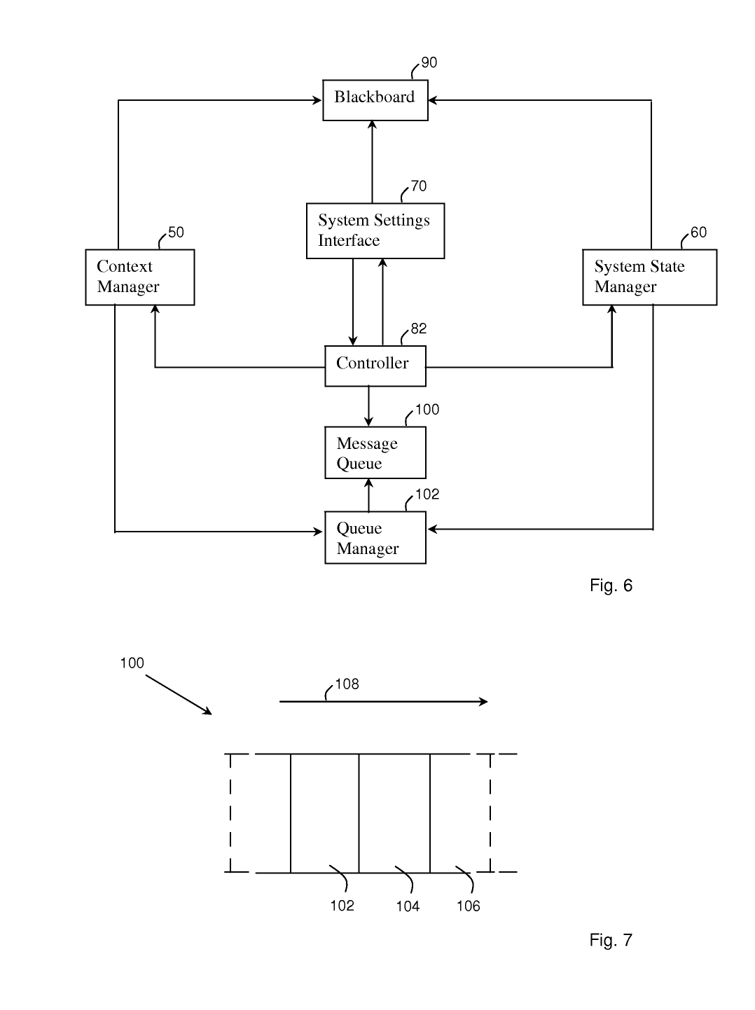

FIG. 6 illustrates the connections of elements of a multimedia subsystem of the computing device 10. The multimedia subsystem comprises context manager 50 described above with reference to FIG. 3. The context manager 50 is connected to a message queue manager 102 which is, in turn, connected to the system state manager 60 described above with reference to FIG. 4. The message queue manager 102 is connected to message queue 100.

The context manager 50, message queue 100 and system state manager 60 are all connected to a controller 82. The controller 82 is further connected to the system settings interface 70 described above with reference to FIG. 5 and the interface 70 is connected to a blackboard 90.

The blackboard 90 is connected to the context manager 50 and to the system state manager 60. The context manager 50 (as described above) is connected to user applications which form a portion of the clients of the media subsystem illustrated in FIG. 6. The context manager 50 receives and handles requests for resources from these clients. The context manager 50 is therefore primarily concerned with user clients. Similarly, the system state manager 60 receives and handles system requests. Therefore the system state manager 60 is primarily concerned with system clients.

The context manager 50 and the system state manager 60 both receive requests for resource allocation from respective clients. Once the client request is received, a corresponding message is generated and communicated to queue manager 102. The queue manager 102 prioritises the messages and or places the messages in the message queue 100 in order.

The controller 82 monitors the message queue 100 and when the message queue presents a new request to the controller 82 this is communicated to the system settings interface 70 and the request is written to the blackboard 90. The interface 70 accesses the corresponding request from the blackboard 90. If the system settings are able to service the particular request (in other words provide rules whereby a resource may be allocated to that request), this will result in a graph (as described in greater detail below) and the graph is written to the blackboard 90. Therefore, the blackboard 90 maintains records (in the form of graphs) corresponding to client requests and the resources allocated to these client requests.

FIG. 7 illustrates the message queue 100 which comprises a plurality of messages 102, 104 and 106. Only a portion of the message queue 100 is illustrated in FIG. 7 for the size and number of messages in the queue will vary during the operation of the multimedia subsystem illustrated in FIG. 6 and will additionally vary depending on the details of the mobile computing device in which the multimedia system is implemented. In the illustrated example, the message queue 100 is a first in, first out queue which is processed in the direction of arrow 108 so that the controller 82 will access the messages of the message queue 100 in the order in which they were written to this queue by the queue manager i.e. in the following order: message 106, then message 104 and then message 102. However, other queuing techniques may be used.

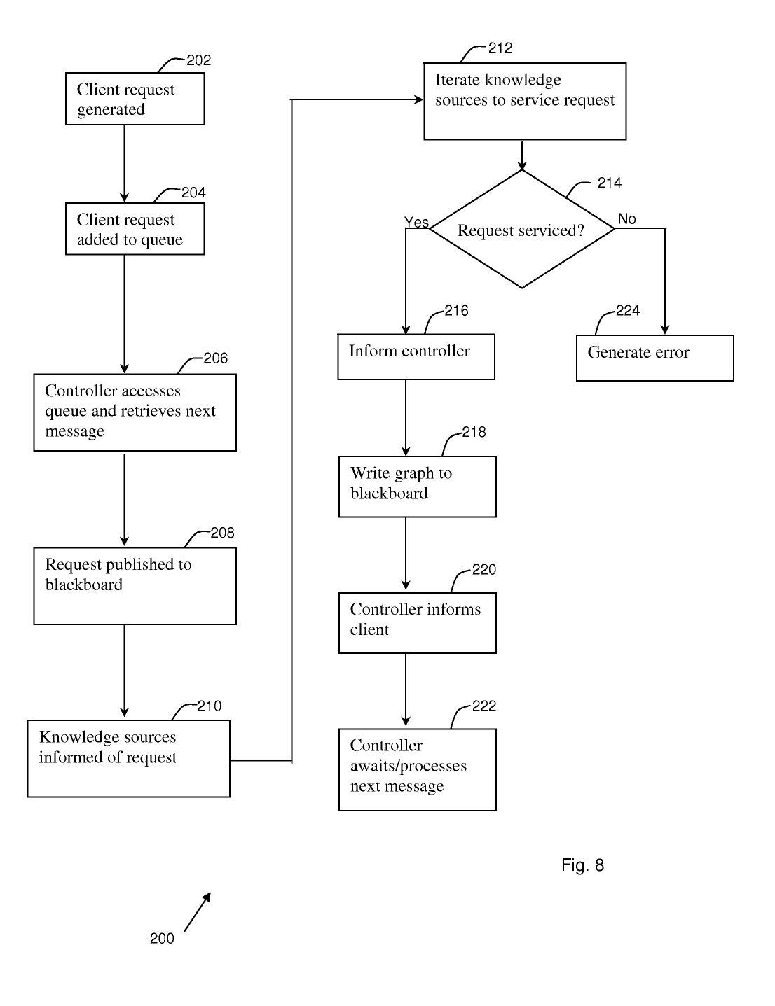

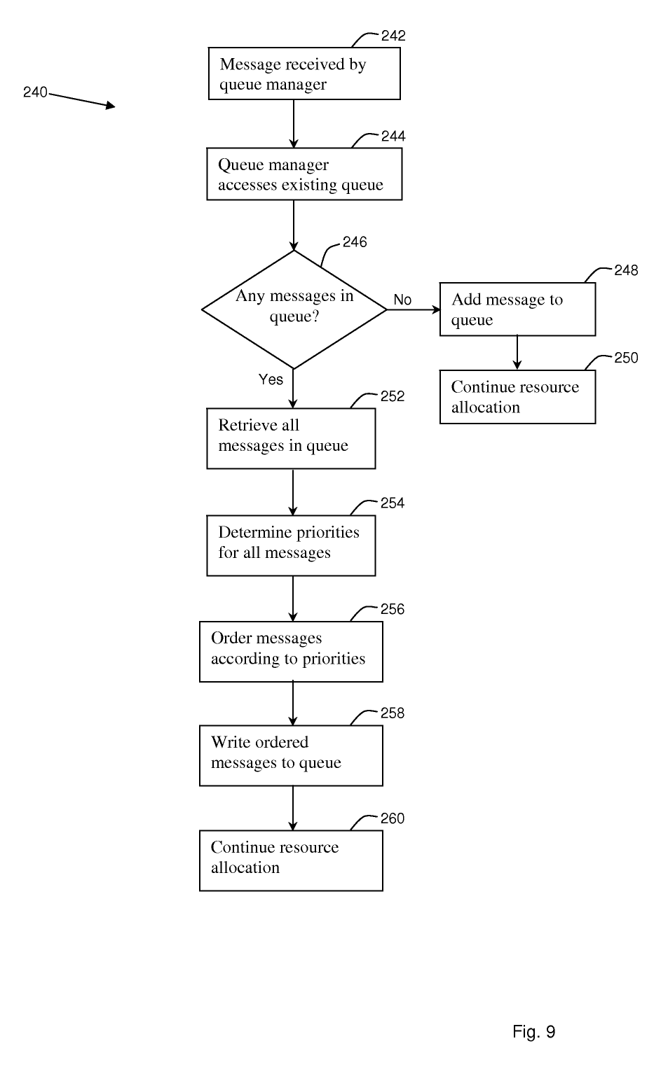

The operation of the multimedia subsystem illustrated in FIG. 6 will now be described with reference to the process of FIG. 8. The process begins at step 202 where a client request is generated. As described, this occurs at the context manager 50 or at the system state manager 60. Once the client requests have been generated, the process moves to step 204 where the client request is added to the message queue 100 by the queue manager 102. The process whereby the queue manager prioritises the received messages and then writes these to the queue is described in further detail below with reference to FIG. 9. Then at step 206, the controller 82 will access the message queue 100 to retrieve the next message in the queue. As described, the messages in the illustrated queue 100 are processed in a first in, first out basis.

Step 208 represents the first step in which the controller processes the message retrieved from the message queue at step 206. At step 208, the controller will publish the request to the blackboard 90. It is to be realised that the request which is published to the blackboard 90 corresponds to the particular message retrieved from the message queue 100. At the following step, step 210, the system settings interface 70 accesses the blackboard 90 and retrieves the request corresponding to the message retrieved from the message queue 100. At step 212 the controller 82 iterates through each of the system settings for which an interface is provided to determine whether the request can be met or not. The iteration of the system settings involves the accessing of each of the system settings connected to interface 70 and determining whether the request can be met by that system setting.

At the following step, step 214, a decision is made whether the request may be serviced or not. This involves aggregating the decisions received by iterating through all the system settings in step 212 and making a decision based thereon. If it is determined at step 214 that the request cannot be serviced the process proceeds to step 224 where an error is generated. Alternatively, if it is determined at step 214 that the request may be serviced, the process proceeds to step 216 where the controller 82 is informed that the request may be serviced. At the following step, step 218, the controller writes the graph which corresponds to the client request and the resource then allocated to that client request to the blackboard 90. At the following step, step 220, the controller will inform the client and pass the client the control over the resource now allocated to this. The process will then proceed to step 222 where the controller 82 retrieves the next message from the message queue 100. Alternatively, at step 222, if there are no more messages to be processed in the message queue 100, the controller 82 will await the next message to be written to the message queue 100.

The above process has been described with reference to requests for resource allocations received by clients. However, the system is also able to deal with changes which affect existing allocations of resources. Such changes may arise from a user making a change to a user profile or a change to hardware component (such as the installation or removal of the hardware component or the change of a setting of the hardware component). The system state manager will detect this change and generate an appropriate message in the queue 100. When this message is processed by the controller 82, each of the existing resource allocations is re-analysed in light of the change and those which are affected are changed accordingly.

FIG. 9 illustrates a process 240 whereby the messages in the queue 100 are prioritised by the queue manager 102. The process illustrated in FIG. 9 corresponds, in part, to step 204 of FIG. 8 where a request is added to the queue. In the initial step of the process of FIG. 9, step 242, the message generated by the context manager 50 or the system state manager 60 is received by the queue manager 102.

The queue manager 102 then accesses the existing queue at step 244. The queue manager 102 determines, in step 246, whether there are any messages in the queue. If it is determined that there are no messages in the queue, the process proceeds to step 248 where the queue manager 102 adds the received message to the queue. Then, the following step 250, the process of resource allocation described above with reference to FIG. 8 will continue.

If however it is determined at step 246 that there are messages in the queue 100, the process will proceed to step 252 where the queue manager 102 retrieves all the messages currently in the queue. Then, at step 254, the queue manager 102 will determine the priorities for all the messages. This will include the messages which were in the queue 100 as well as the new message which has arrived.

To determine the priorities for the messages, queue manager 102 includes a set of rules which determine the priorities of the messages. In the current embodiment, the following priorities are applied: all messages received from the context manager 50 are assigned the lowest priority. Of the messages received from the system state manager 60, any messages relating to resource requests from system clients are prioritised below messages relating to a change which may affect allocations of resources. The choice of priorities to apply will vary between use cases.

Once the priorities for the messages have been determined, the process proceeds to step 256 where the messages are ordered according to the determined priorities. This step involves placing the messages having the higher priority in front of those messages with a lower priority.

Then, at step 258, the ordered messages are written to the queue 100. The processing of resource allocation will then continue in step 260. In the present embodiment this will involve returning to step 206 of FIG. 8 described above.

Therefore, embodiments of the invention ensure that messages which are more critical are prioritised over messages which are less critical. This ensures that more important resource allocations are processed before less important ones.

In the embodiment described above, a certain rule set exists for prioritising the messages. It will be realised however that this rule set may be replaced by a simpler, or a more complex, rule set. In an alternate embodiment, rules are specified for each request received. In a simpler embodiment, requests received from the system state manager 60 are prioritised over requests received from the context manager 50. In a further embodiment, the clients are characterised according to a security arrangement. In the Symbian operating system this is the PlatSec arrangement. In this embodiment, the messages are prioritised according to the security-related rating of the corresponding client. Messages relating to more trusted clients can therefore be prioritised over those corresponding to less trusted clients.

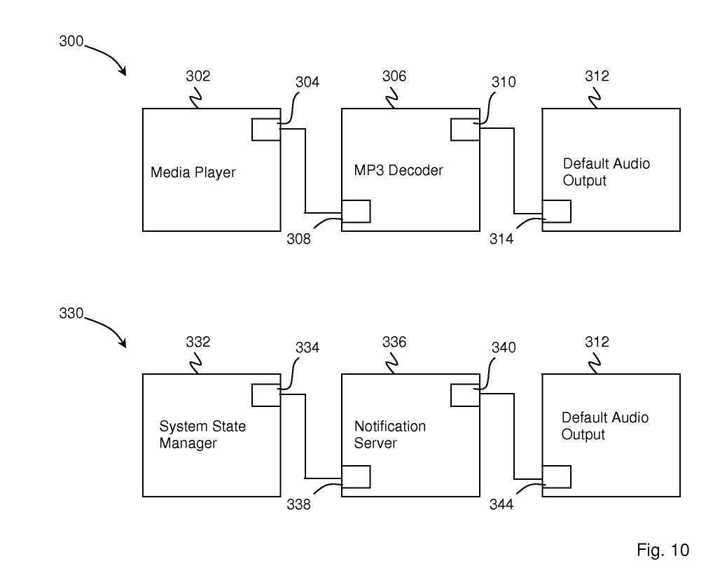

FIG. 10 illustrates two graphs created according to some of the above embodiments. Graph 300 represents the allocation of resources to a media player 302 which is in the process of playing an MP3 file. The media player client communicates the request to the context manager 50 specifying that the source is an MP3 file and requesting an MP3 decoder as well as the default audio output. In this example, the MP3 decoder and the default audio output requested by the media player represent the resources to be allocated. The system settings interfaced by system settings interface 70 would allocate the correct MP3 decoder 306 and the default audio output 312 to the resource request generated by the media player 302 according to any rules pertaining thereto. As a result of this, the graph 300 illustrated in FIG. 10 would arise. The media player 302 includes a source 304 which is connected to a sink 308 of MP3 decoder 306. MP3 decoder 306 also includes a source 310 which is connected to a sink 314 of the default audio output 312.

Similarly, FIG. 10 illustrates a graph 330 which corresponds to the system state manager 60 requesting an audio notification to a user of the device 10. The system state manager is represented in the graph 330 by block 332 which includes a source 334. In this example the source 334 is the particular notification to be issued which may, for example, be an MP3 sound file. The source 334 is connected to a sink on a notification server 336. The notification server is able to receive the sources for notifications and quickly reproduce the required notification. The notification server 336 includes a source 340 which is connected to a sink 344 or the default audio output 312.

Of the graphs illustrated in FIG. 10, the graph 330 has a higher priority than that of graph 300 as graph 330 relates to a system notification. Therefore, the request received from system state manager (i.e. block 332) would be prioritised over the message corresponding to the request from the media player (block 302).

As used here in, the term “resource” relates to any software or hardware component which may be utilised to service a particular request. With reference to a multimedia system, the term “requests” may refer to software components such as media sources, media effects, media decoders and media encoders and/or hardware components such as speakers, displays, microphones, Bluetooth headsets etc.

Embodiments of the present invention may be implemented in software, hardware, application logic or a combination of software, hardware and application logic. The software, application logic and/or hardware may reside in a processor, in memory or in dedicated hardware circuitry. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device. A computer-readable medium may comprise a computer-readable storage medium that may be any media or means that can contain or store the instructions for use by or in connection with an instruction execution system, apparatus, or device.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1.-29. (canceled)

30. A method comprising:
placing a message corresponding to a request, originating from a client, in a queue of messages;
processing the message by allocating a resource of a computing device to the corresponding client with reference to a system setting;
maintaining a record of resources allocated to clients; and
where the queue of messages comprises more than one message, prioritising the order in which the messages are processed.

31. The method according to claim 30 wherein the requests originate from a user client or a system client and wherein messages originating from system clients are prioritised over those originating from user clients.

32. The method according to claim 31 wherein at least one of the messages in the queue comprises a message relating to a system change which may affect existing allocations of resources, the method comprising the step of prioritising the message relating to the system change over messages corresponding to client requests for resource allocation.

33. The method according to claim 32 wherein the change affecting existing allocations of resources originates from one or more of
a change to a user profile;
a change to the one or more system settings; or
a change to a hardware component.

34. The method according to claim 33 wherein the change to the hardware component comprises one or more of installing the hardware component; removing the hardware component; or changing a setting of the hardware component.

35. The method according claim 30, wherein a plurality of clients have corresponding security ratings determining a level of trustworthiness of the clients, the method comprising prioritising the messages according to the security rating of the corresponding clients.

36. The method according to claim 30 wherein the queue is a first in, first out queue.

37. The method according to claim 30 wherein the record of the resource allocated to the client comprises at least one filter graph, the filter graph linking the client and the resource of the record.

38. Apparatus comprising:
at least one processor; and
at least one memory including computer program code;
the at least one memory and the computer program code being configured to, working with the at least one processor, cause the apparatus to perform at least the following:
cause a message, corresponding to a request originating from a client, to be placed in a queue of messages;
cause the message to be processed by allocating a computing device resource to the corresponding client with reference to a system setting;
cause a record of resources allocated to clients to be maintained; and
where the queue of messages comprises more than one message, causing the order in which the messages are processed to be prioritised.

39. Apparatus according to claim 38 wherein the requests originate from a user client or a system client and wherein causing the order in which the messages are processed to be prioritised, comprises prioritising messages originating from system clients over those originating from user clients.

40. Apparatus according to claim 39 wherein at least one of the messages in the queue comprises a message relating to a system change which may affect existing allocations of resources, wherein causing the order in which the messages are processed to be prioritised comprises prioritising the message relating to the system change over messages corresponding to client requests for resource allocation.

41. Apparatus according to claim 40 wherein the change affecting existing allocations of resources originates from one or more of
a change to a user profile;
a change to the one or more system settings; or
a change to a hardware component.

42. Apparatus according to claim 41 wherein the change to the hardware component comprises one or more of installing the hardware component removing the hardware component; or changing a setting of the hardware component.

43. Apparatus according to any of claims 38, wherein a plurality of clients have corresponding security ratings determining a level of trustworthiness of the clients, and wherein causing the order in which the messages are processed to be prioritised, comprises prioritising the messages according to the security rating of the corresponding clients.

44. Apparatus according to claim 38 wherein the queue is a first in, first out queue.

45. Apparatus according to claim 38 wherein the record of the resource allocated to the client comprises at least one filter graph, the filter graph linking the client and the resource of the record.

46. A computer program product comprising at least one computer-readable storage medium, the computer-readable storage medium comprising a set of instructions, which, when executed by one or more processors, cause an apparatus at least to perform:
place a message corresponding to a request, originating from a client, in a queue of messages;
process the message by allocating a resource of a computing device to the corresponding client with reference to a system setting;
maintain a record of resources allocated to clients; and
where the queue of messages comprises more than one message, prioritising the order in which the messages are processed.

47. A computer program product according to claim 46 wherein the requests originate from a user client or a system client and wherein causing the order in which the messages are processed to be prioritised, comprises prioritising messages originating from system clients over those originating from user clients.

48. A computer program product according to claim 47 wherein at least one of the messages in the queue comprises a message relating to a system change which may affect existing allocations of resources, wherein causing the order in which the messages are processed to be prioritised comprises prioritising the message relating to the system change over messages corresponding to client requests for resource allocation.

49. A computer program product according to claim 48 wherein the change affecting existing allocations of resources originates from one or more of:
a change to a user profile;
a change to the one or more system settings; or
a change to a hardware component.
